(19) United States
(12) Patent Application Publication
(10) Pub. No.: US 2018/0147819 A1
(43) Pub. Date: May 31, 2018

(54) GLASS PLATE

(71) Applicant: ASAHI GLASS COMPANY, LIMITED, Chiyoda-ku (JP)

(72) Inventors: Naoaki Miyamoto, Tokyo (JP); Masabumi Ito, Tokyo (JP); Kazuya Ishikawa, Tokyo (JP); Kazuya Takemoto, Tokyo (JP); Naoya Wada, Tokyo (JP)

(73) Assignee: ASAHI GLASS COMPANY, LIMITED, Chiyoda-ku (JP)

(21) Appl. No.: 15/879,541

(22) Filed: Jan. 25, 2018

Related U.S. Application Data
(63) Continuation of application No. PCT/JP2016/073869, filed on Aug. 16, 2016.

(30) Foreign Application Priority Data
Aug. 19, 2015 (JP) 2015-161585

(51) Int. Cl. B32B 17/10; B32B 7/04

(52) U.S. Cl. CPC B32B 17/1055; B32B 7/04; B32B 17/10018; B32B 17/10036

(57) ABSTRACT

A glass sheet includes a main surface, a first end surface perpendicular to the main surface, and a chamfered surface provided adjacent to the main surface and between the main surface and the first end surface. In a cross section perpendicular to the main surface and the first end surface, a point at which an imaginary line of the first end surface and an imaginary line of the chamfered surface intersect is a first intersection point, and a point at which a straight line that passes through the first intersection point, is perpendicular to the imaginary line of the first end surface and is extended toward the chamfered surface intersects the chamfered surface is a second intersection point. A line segment connecting the first intersection point and the second intersection point has a length of 10 μm or less.

### TECHNICAL FIELD

The present invention relates to a glass sheet.

### BACKGROUND ART

A liquid crystal display device represented by a liquid crystal television, a digital signage or the like includes a planar light emitting device constituting a backlight and a liquid crystal panel that is disposed opposite to a light emission surface of the planar light emitting device. The planar light emitting devices include a direct-lit type and an edge-lit type, and the edge-lit type one, which can reduce the size of light sources, are frequently used. An edge-lit type planar light emitting device has a light source, a light guide sheet, a reflection sheet, a variety of optical sheets (a diffusion sheet, a brightness improvement sheet and the like), and the like. PTLs 1 and 2 disclose the using a glass sheet having a high internal transmittance, a high strength and excellent thermal resistance as a light guide sheet of a planar light emitting device.

In addition, methods for measuring up to an edge peripheral portion of a measurement subject at a high speed and a high accuracy regardless of the shape of the subject are known. In a method disclosed by PTL 3, an optical measurement device constituted of a line illumination and a line sensor is used, and a telecentric optical system is selected as an imaging optical system. In this method, it is possible to measure the surface condition of a measurement subject member such as a round substrate up to a vicinity of a peripheral portion of the measurement subject member without being affected by the lack of light quantity caused by a light shielding sheet. Therefore, compared with a case in which a non-telecentric optical system is used as the imaging optical system, it is possible to further broaden the measurable region. When a black and white binarization treatment is carried out on the above-measured image as in a method disclosed by PTL 4, it is possible to evaluate the end surface property of a glass substrate or the like at a high accuracy.

### CITATION LIST

### Patent Literature

PTL 1: JP-A-2013-093195

PTL 2: JP-A-2013-030279

PTL 3: JP-A-2012-021780

PTL 4: WO 2012/005019

### SUMMARY OF INVENTION

### Technical Problem

Even when a glass sheet is used as, for example, a light guide sheet or the like of a planar light emitting device, methods for measuring an end surface property by the optical system as described in PTLs 3 and 4 are useful in, particularly, on-line inspection (one hundred percent inspection). In the case of off-line inspection (sample inspection), it is possible to carry out high-accuracy measurement by, for example, a scanning-type measurement device or the like; however, in the case of on-line inspection, it is necessary to measure the entire end surface at a high speed in a non-destructive manner, and measuring methods other than the one by optical system are not realistic.

In addition, when a glass sheet is used as, for example, a light guide sheet or the like of a planar light emitting device, the measurement accuracy of end surface property (dimensions and the surface condition) is particularly required. This is because, in a light guide sheet, light is incident on an end surface, and thus the dimensions or surface condition of the end surface significantly influence the quantity or uniformness of the incident light and are related to the quality of products. Therefore, it is necessary to measure not only the surface condition of the end surface but also the dimensions by carrying out a black and white binarization in the same manner as in the method of PTL 4.

However, as a result of intensive studies, the inventors of the present application found that the end surface property of glass sheets of a related art is not suitable for the accurate measurement of end surface property by the above-described optical system. In addition, as a result of additional studies, it was found that, by controlling the end surface property of glass sheets in certain ranges in advance, it is possible to suppress unnecessary scattered light attributed to the end surface property. Therefore, it was found that the measurement error is suppressed, projected images can be detected at a higher accuracy, and it is possible to measure end surface property at a sufficient accuracy by an optical system.

An object of the present invention is to provide a glass sheet suitable for the accurate measurement of end surface property by an optical system in a case in which a glass member is used as a light guide sheet.

### Solution to Problem

According to an aspect of the present invention, there is provided a glass sheet including a main surface, a first end surface perpendicular to the main surface, and a chamfered surface provided adjacent to the main surface and between the main surface and the first end surface, in which, in a cross section perpendicular to the main surface and the first end surface, in the case where a point at which an imaginary line of the first end surface and an imaginary line of the chamfered surface intersect is a first intersection point, and a point at which a straight line that passes through the first intersection point, is perpendicular to the imaginary line of the first end surface and is extended toward the chamfered surface intersects the chamfered surface is a second intersection point, a line segment connecting the first intersection point and the second intersection point has a length of 10 μm or less.

According to another aspect of the present invention, there is provided a glass sheet including a main surface, a first end surface perpendicular to the main surface, and a chamfered surface provided adjacent to the main surface and between the main surface and the first end surface, in which, in a cross section perpendicular to the main surface and the first end surface, in the case where a point at which an imaginary line of the first end surface and an imaginary line of the chamfered surface intersect is a first intersection point, and a point at which a straight line that passes through the first intersection point, is perpendicular to the imaginary line of the first end surface and is extended toward the chamfered surface intersects the chamfered surface is a second intersection point, the chamfered surface at the second intersection point has a curvature radius of 110 μm or less.

### Advantageous Effects of Invention

According to the present invention, it is possible to accurately measure the end surface property of a glass sheet for being used as, for example, a light guide sheet of a planar light emitting device.

### BRIEF DESCRIPTION OF DRAWINGS

FIG. 1 is a side view of a liquid crystal display device illustrating a schematic constitution of the liquid crystal display device.

FIG. 2 is a plan view of a glass sheet.

FIG. 3 is an overall perspective view of the glass sheet.

FIG. 4 is an end surface enlarged view of the glass sheet.

FIG. 5 is a cross-sectional enlarged view of the glass sheet.

FIG. 6 is a cross-sectional enlarged view of the glass sheet.

FIG. 7 is a cross-sectional enlarged view of the glass sheet.

FIG. 8 is a step view of a method for manufacturing a glass sheet according to the present embodiment.

FIG. 9 is a plan view of a glass material of the glass sheet.

FIG. 10 is a plan view of a glass base material from which the glass material is cut out and a disposition view of an inspection device.

FIG. 11 is a plan view of the glass base material from which the glass material is cut out and a different disposition view of the inspection device.

FIG. 12 is an enlarged view of a light entrance end surface of a glass sheet according to Experiment 1.

FIG. 13 is an enlarged view of a light entrance end surface of a glass sheet according to Experiment 2.

### DESCRIPTION OF EMBODIMENTS

Next, a preferred embodiment of the present invention will be described with reference to the accompanying drawings. In the present specification, unless particularly otherwise specified, “to” expressing numerical ranges is used to mean that numerical values before and after “to” are included as the upper limit value and the lower limit value.

Regarding the description in the drawings, the same or corresponding member or component will be given the same or corresponding reference sign and redundant explanation will be omitted. In addition, unless particularly otherwise designated, the drawings are not intended to indicate relative ratios between members or components. Therefore, specific dimensions can be determined by persons skilled in the art in light of the following unlimited embodiment.

[Liquid Crystal Display Device 10]

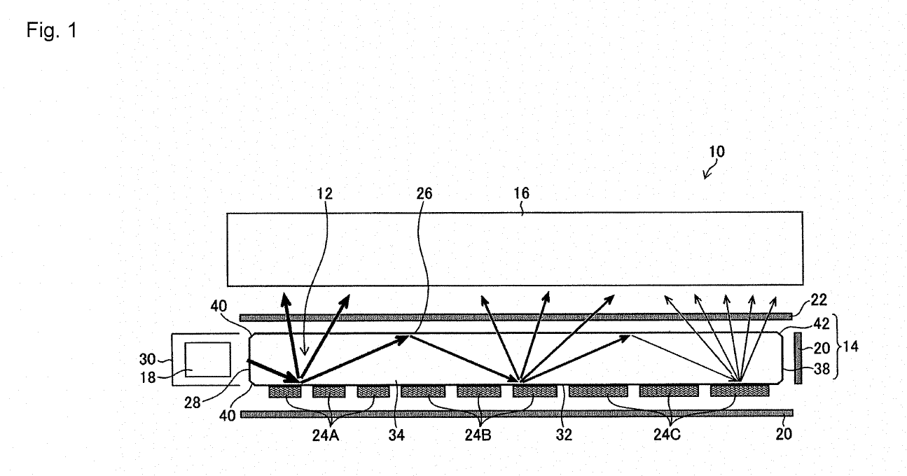

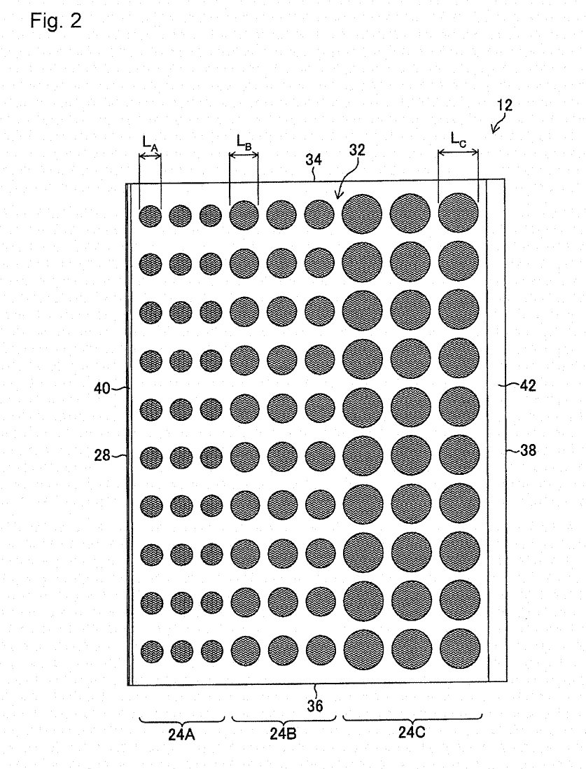

FIG. 1 is a side view of a liquid crystal display device 10 illustrating a schematic constitution of the liquid crystal display device 10. FIG. 2 is a plan view of a glass sheet 12 of an embodiment combined into the liquid crystal display device 10.

As illustrated in FIG. 1, the liquid crystal display device 10 is constituted of a planar light emitting device 14 having the glass sheet 12 and a liquid crystal panel 16. The liquid crystal display device 10 is mounted in, for example, electronic devices for which thickness reduction is required such as liquid crystal televisions and digital signage.

<Liquid Crystal Panel 16>

The liquid crystal panel 16 is constituted of an alignment layer, a transparent electrode, a glass substrate, and a polarization filter laminated together so as to sandwich a liquid crystal layer that is disposed in a center in a thickness direction. In addition, on one surface of the liquid crystal layer, a color filter is disposed. Molecules in the liquid crystal layers rotate around a light distribution axis by applying a driving voltage to the transparent electrode and thus carry out predetermined displays.

<Planar Light Emitting Device 14>

As the planar light emitting device 14, an edge-lit type one is employed in order for thickness reduction. The planar light emitting device 14 has a light source 18, the glass sheet 12, a reflection sheet 20, a variety of optical sheet (a diffusion sheet, a brightness improvement sheet and the like) 22, and reflection dots 24A to 24C.

Light incident from the light source 18 into the inside of the glass sheet 12 progresses while being repeatedly mirror-reflected by an inner surface of a light emission surface 26 and an inner surface of a light reflection surface 32 of the glass sheet 12 as illustrated by arrows in FIG. 1. In addition, light having a progress direction that is changed by the reflection dots 24A to 24C and the reflection sheet 20 is emitted to the outside from the light emission surface 26 of the glass sheet 12 which faces the liquid crystal panel 16. Light emitted to the outside is diffused by a variety of optical sheet (which is constituted of a diffusion sheet, a brightness improvement sheet and the like, and may be a single body or a plurality thereof) 22 and is then incident on the liquid crystal panel 16.

The light source 18 is not particularly limited, and an LED (light emitting diode), a hot-cathode tube or a cold-cathode tube can be used. The light source 18 is disposed at a location facing a light entrance end surface (first end surface) 28 of the glass sheet 12.

In addition, a reflector 30 is provided on a rear surface side of the light source 18, whereby an efficiency of making light that is radially emitted from the light source 18 incident on the glass sheet 12 is increased.

The reflection sheet 20 may be disposed so as to face the light reflection surface 32 of the glass sheet 12. The reflection sheet 20 is constituted by coating a surface of a resin sheet of an acrylic resin or the like with a light reflection member. Additionally, the reflection sheet 20 may be disposed on a non-light entrance end surface 34, 36 or 38 (refer to FIG. 2). The reflection sheet 20 may be disposed with a space from the glass sheet 12 placed or may be attached to the glass sheet 12 by using an adhesive. The light reflection surface 32 is a main surface of the glass sheet 12 which faces the light emission surface 26. In addition, the light entrance end surface 28 is an end surface of the glass sheet 12 which faces the light source 18. The non-light entrance end surfaces 34, 36 and 38 are end surfaces of the glass sheet 12 except for the light entrance end surface 28.

The reflection sheet 20 will be described in detail below; however, instead of using the reflection sheet 20, reflection films may be formed on the light reflection surface 32 and the non-light entrance end surfaces 34, 36 and 38 of the glass sheet 12 by means of printing, coating or the like.

As a material of the resin sheet constituting the reflection sheet 20, an acrylic resin is exemplified, but the material is not limited thereto, and it can be used, for example, a polyester resin such as a PET resin, a urethane resin, materials obtained by combining those, and the like.

As a light reflection member constituting the reflection sheet 20, use can be made of, for example, a film obtained by making a resin to contain air bubbles or particles, a metal-deposited film or the like.

The reflection sheet 20 may be provided with an adhesive layer and be attached to the glass sheet 12. As the adhesive layer provided on the reflection sheet 20, it can be used, for example, an acrylic resin, a silicone resin, a urethane resin, synthetic rubber, or the like.

The thickness of the reflection sheet 20 is not particularly limited, it can be used for one having a thickness of, for example, 0.01 to 0.50 mm.

As the variety of optical sheet 22, it can be used for milky white acrylic resin films and the like. Since the variety of optical sheet 22 diffuses light emitted from the light emission surface 26 of the glass sheet 12, a rear surface side of the liquid crystal panel 16 is irradiated with uniform light without brightness unevenness. The variety of optical sheet 22 is disposed opposite to the glass sheet 12 at a predetermined location so as not to come into contact with the glass sheet 12.

<Properties of Glass Sheet 12>

The glass sheet 12 is constituted of high transparency glass. In the embodiment, as a material of glass that is used as the glass sheet 12, multicomponent oxide glass is used.

Specifically, as the glass sheet 12, it is preferable to use glass having an average internal transmittance of 90% or more at a light path length of 50 mm and a wavelength of 400 to 700 nm. In such a case, it is possible to suppress the attenuation of light incident on the glass sheet 12 as much as possible. The transmittance at a light path length of 50 mm is measured for a sample A sampled by cutting a glass sheet 12 in a direction perpendicular to the main surface into a size of 50 mm in length×50 mm in width from the center portion of the glass sheet, in which first and second cut surfaces opposite to each other are made to have an arithmetic average roughness Ra≤0.03 μm, by a spectral measurement device (for example, UH4150: manufactured by Hitachi High-Technologies Corporation) capable of measurement at a light path length of 50 mm in a 50 mm length from the first cut surface in the normal direction, while the beam width of incident light is set to be narrower than the sheet thickness with a slit or the like. A loss by reflection on the surface is removed from the transmittance at a light path length of 50 mm obtained in the above-described manner, thereby obtaining the internal transmittance at a light path length of 50 mm. The average internal transmittance at a light path length of 50 mm and a wavelength of 400 to 700 nm is preferably 92% or more, more preferably 95% or more, still more preferably 98% or more, and particularly preferably 99% or more.

A total amount A of the content of iron in the glass that is used as the glass sheet 12 is preferably 100 mass ppm or less from the viewpoint of satisfying the above-described average internal transmittance at a light path length of 50 mm and a wavelength of 400 to 700 nm, more preferably 40 mass ppm or less, and still more preferably 20 mass ppm or less. On the other hand, the total amount A of the content of iron in the glass that is used as the glass sheet 12 is preferably 5 mass ppm or more from the viewpoint of improving the solubility of glass during the manufacturing of the multicomponent oxide glass, more preferably 8 mass ppm or more, and still more preferably 10 mass ppm or more. The total amount A of the content of iron in the glass that is used as the glass sheet 12 can be adjusted by the amount of iron being added during the manufacturing of the glass.

In the present specification, the total amount A of the content of iron in the glass is represented by the content of Fe₂O₃, but not all iron present in the glass is present as Fe³⁺ (trivalent iron). Generally, in the glass, Fe³⁻ and Fe²⁺ (divalent iron) are present at the same time. Fe^{2|} and Fe^{3|} have an absorbance in a wavelength range of 400 to 700 nm, but the absorption coefficient (11 cm⁻¹ Mol⁻¹) of Fe²⁺ is an order of magnitude greater than the absorption coefficient (0.96 cm⁻¹ Mol⁻¹) of Fe³⁺, and thus Fe²⁺ further decreases the internal transmittance at a wavelength of 400 to 700 nm. Therefore, the content of Fe²⁺ is preferably small from the viewpoint of increasing the internal transmittance at a wavelength of 400 to 700 nm.

A content B of Fe²⁻ in the glass that is used as the glass sheet 12 is preferably 20 mass ppm or less from the viewpoint of satisfying the above-described average internal transmittance in the visible light range at an effective light path length, more preferably 10 mass ppm or less, and still more preferably 5 mass ppm or less. On the other hand, the content B of Fe^{2|} in the glass that is used as the glass sheet 12 is preferably 0.01 mass ppm or more from the viewpoint of improving the solubility of glass during the manufacturing of the multicomponent oxide glass, more preferably 0.05 mass ppm or more, and still more preferably 0.1 mass ppm or more.

The content of Fe²⁺ in the glass that is used as the glass sheet 12 can be adjusted by the amount of an oxidant being added during the manufacturing of the glass, the dissolution temperature or the like. The specific kind of the oxidant being added during the manufacturing of the glass and the added amount thereof will be described below. The content A of Fe₂O₃ is the content (mass ppm) of all iron converted to Fe₂O₃ obtained by fluorescent X-ray measurement. The content B of Fe²⁺ was measured according to ASTM C169-92. The measured content of Fe²⁺ was expressed by being converted to Fe₂O₃.

Specific examples of the composition of the glass that is used as the glass sheet 12 will be described below. However, the composition of the glass that is used as the glass sheet 12 is not limited thereto.

A constitution example (constitution example A) of the glass that is used as the glass sheet 12 includes, in terms of the oxide-based mass percentage, 60% to 80% of SiO₂, 0% to 7% of Al₂O₃, 0% to 10% of MgO, 0% to 20% of CaO, 0% to 15% of SrO, 0% to 15% of BaO, 3% to 20% of Na₂O, 0% to 10% of K₂O, and 5 to 100 mass ppm of Fe₂O₃.

Another constitution example (constitution example B) of the glass that is used as the glass sheet 12 includes, in terms of the oxide-based mass percentage, 45% to 80% of SiO₂, more than 7% and 30% or less of Al₂O₃, 0% to 15% of B₂O₃, 0% to 15% of MgO, 0% to 6% of CaO, 0% to 5% of SrO, 0% to 5% of BaO, 7% to 20% of Na₂O, 0% to 10% of K₂O, 0% to 10% of ZrO₂, and 5 to 100 mass ppm of Fe₂O₃.

Still another constitution example (constitution example C) of the glass that is used as the glass sheet 12 includes, in terms of the oxide-based mass percentage, 45% to 70% of SiO₂, 10% to 30% of Al₂O₃, 0% to 15% of B₂O₃, a total of 5% to 30% of MgO, CaO, SrO, and BaO, a total of 0% or more and less than 3% of Li₂O, Na₂O and K₂O, and 5 to 100 mass ppm of Fe₂O₃.

However, the glass that is used as the glass sheet 12 is not limited thereto.

Compositional ranges of the components of the composition of the glass of the glass sheet 12 of the present embodiment having the above-described components will be described below. The units of the contents of each of the compositions are all oxide-based mass percentage or mass ppm which will be simply indicated as “%” or “ppm”.

SiO₂ is a main component of the glass. The content of SiO₂ is preferably 60% or more and more preferably 63% or more in the constitution example A, preferably 45% or more and more preferably 50% or more in the constitution example B, and preferably 45% or more and more preferably 50% or more in the constitution example C in terms of the oxide-based mass percentage in order to maintain the weather resistance and devitrification characteristics of the glass.

On the other hand, the content of SiO₂ is preferably 80% or less and more preferably 75% or less in the constitution example A, preferably 80% or less and more preferably 70% or less in the constitution example B, and preferably 70% or less and more preferably 65% or less in the constitution example C in order to facilitate dissolution, to improve bubble qualities, additionally, to suppress the content of divalent iron (Fe²⁺) in the glass at a low level, and to improve the optical characteristics.

Al₂O₃ is an essential component that improves the weather resistance of the glass in the constitution examples B and C. The content of Al₂O₃ is preferably 1% or more and more preferably 2% or more in the constitution example A, preferably more than 7% and more preferably 10% or more in the constitution example B, and preferably 10% or more and more preferably 13% or more in the constitution example C in order to maintain the weather resistance which is practically necessary in the glass of the present embodiment.

However, in order to suppress the content of divalent iron (Fe²⁻) at a low level, to improve the optical characteristics and to improve bubble qualities, the content of Al₂O₃ is preferably 7% or less and more preferably 5% or less in the constitution example A, preferably 30% or less and more preferably 23% or less in the constitution example B, and preferably 30% or less and more preferably 20% or less in the constitution example C.

B₂O₃ is a component that accelerates the melting of a glass raw material and improves the mechanical characteristics or the weather resistance, and the content of B₂O₃ is preferably 5% or less and more preferably 3% or less in the glass A and preferably 15% or less and more preferably 12% or less in the constitution examples B and C in order to prevent the occurrence of disadvantages such as the generation of ream by volatilization and the corrosion of furnace walls.

Alkali metal oxides such as Li₂O, Na₂O and K₂O are useful component for accelerating the melting of the glass raw material and adjusting thermal expansion, the viscous property and the like.

Therefore, the content of Na₂O is preferably 3% or more and more preferably 8% or more in the constitution example A. The content of Na₂O is preferably 7% or more and more preferably 10% or more in the constitution example B. However, in order to maintain clarity during dissolution and maintain the bubble qualities of glass to be manufactured, the content of Na₂O is preferably set to 20% or less and more preferably set to 15% or less in the constitution examples A and B and preferably set to 3% or less and more preferably set to 1% or less in the constitution example C.

In addition, the content of K₂O is preferably 10% or less and more preferably 7% or less in the constitution examples A and B and preferably 2% or less and more preferably 1% or less in the constitution example C.

In addition, Li₂O is an arbitrary component; however, in order to facilitate vitrification, suppress the content of iron which is included as an impurity derived from the raw material at a low level, and suppress the batch costs at a low level, Li₂O may be contained in an amount of 2% or less in the constitution examples A, B and C.

In addition, in order to maintain clarity during dissolution and maintain the bubble qualities of glass to be manufactured, the total content of these alkali metal oxides (Li₂O+Na₂O+K₂O) is preferably 5% to 20% and more preferably 8% to 15% in the constitution examples A and B and preferably 0% to 2% and more preferably 0% to 1% in the constitution example C.

Alkali earth metal oxides such as MgO, CaO, SrO, and BaO are useful components for accelerating the melting of the glass raw material and adjusting thermal expansion, the viscous property and the like.

MgO has an action of weakening the viscous property during the dissolution of the glass and accelerating the dissolution. In addition, it has an action of decreasing the specific weight and preventing the easy generation of marks on the glass sheet, and thus it may be contained in the constitution examples A, B and C. In addition, in order to decrease the thermal expansion coefficient of the glass and improve the devitrification characteristics, the content of MgO is preferably 10% or less and more preferably 8% or less in the constitution example A, preferably 15% or less and more preferably 12% or less in the constitution example B, and preferably 10% or less and more preferably 5% or less in the constitution example C.

CaO is a component that accelerates the melting of the glass raw material and adjusts the viscous property, thermal expansion and the like and thus may be contained in the constitution examples A, B and C. In order to obtain the above-described action, the content of CaO is preferably 3% or more and more preferably 5% or more in the constitution example A. In addition, in order to improve devitrification, it is preferably 20% or less and more preferably 10% or less in the constitution example A and preferably 6% or less and more preferably 4% or less in the constitution example B.

SrO has an effect of increasing the the thermal expansion coefficient and decreasing the high-temperature viscosity of the glass. In order to obtain such an effect, SrO may be contained in the constitution examples A, B and C. However, in order to suppress the theimal expansion coefficient of the glass at a low level, the content of SrO is preferably set to 15% or less and more preferably set to 10% or less in the constitution examples A and C and preferably set to 5% or less and more preferably set to 3% or less in the constitution example B.

BaO, similar to SrO, has an effect of increasing the thermal expansion coefficient and decreasing the high-temperature viscosity of the glass. In order to obtain such an effect, BaO may be contained. However, in order to suppress the theimal expansion coefficient of the glass at a low level, it is preferably set to 15% or less and more preferably set to 10% or less in the constitution examples A and C and preferably set to 5% or less and more preferably set to 3% or less in the constitution example B.

In addition, in order to suppress the theimal expansion coefficient at a low level, to improve the devitrification characteristics, and to maintain the strength, the total content of these alkali earth metal oxides (MgO+CaO+SrO+BaO) is preferably 10% to 30% and more preferably 13% to 27% in the constitution example A, preferably 1% to 15% and more preferably 3% to 10% in the constitution example B, and preferably 5% to 30% and more preferably 10% to 20% in the constitution example C.

In the glass composition of the glass of the glass sheet 12 of the present embodiment, in order to improve the thermal resistance and surface hardness of the glass, as an arbitrary component, 10% or less and preferably 5% or less of ZrO₂ may be contained in the constitution examples A, B and C. In the case of 10% or less, the glass does not easily devitrify.

In the glass composition of the glass of the glass sheet 12 of the present embodiment, in order to improve the solubility of the glass, 5 to 100 ppm of Fe₂O₃ may be contained in the constitution examples A, B and C. The preferred range of the amount of Fe₂O₃ is as described above.

In addition, the glass of the glass sheet 12 of the present embodiment may contain SO₃ as a clarifying agent. In this case, the content of SO₃ is preferably more than 0% and 0.5% or less in terms of the mass percentage. It is more preferably 0.4% or less, still more preferably 0.3% or less, and still more preferably 0.25% or less.

In addition, the glass of the glass sheet 12 of the present embodiment may contain one or more of Sb₂O₃, SnO₂ and As₂O₃ as an oxidant and a clarifying agent. In this case, the content of Sb₂O₃, SnO₂ or As₂O₃ is preferably 0% to 0.5% in terms of the mass percentage. It is more preferably 0.2% or less, still more preferably 0.1% or less, and still more preferably substantially not contained.

However, since Sb₂O₃, SnO₂ and As₂O₃ act as an oxidant of the glass, those may be added in the above-described range for the purpose of adjusting the amount of Fe²⁺ in the glass. However, As₂O₃ is preferably substantially not contained in terms of the environment.

In addition, the glass of the glass sheet 12 of the present embodiment may also contain NiO. In the case of containing NiO, NiO also functions as a coloring component, and thus the content of NiO is preferably set to 10 ppm or less of the total amount of the above-described glass composition. Particularly, from the viewpoint of preventing a decrease in the internal transmittance of the glass sheet at a wavelength of 400 to 700 nm, NiO is preferably set to 1.0 ppm or less and more preferably set to 0.5 ppm or less.

The glass of the glass sheet 12 of the present embodiment may also contain Cr₂O₃. In the case of containing Cr₂O₃, Cr₂O₃ also functions as a coloring component, and thus the content of Cr₂O₃ is preferably set to 10 ppm or less of the total amount of the above-described glass composition. Particularly, from the viewpoint of preventing a decrease in the internal transmittance of the glass sheet at a wavelength of 400 to 700 nm, Cr₂O₃ is preferably set to 1.0 ppm or less and more preferably set to 0.5 ppm or less.

The glass of the glass sheet 12 of the present embodiment may also contain MnO₂. In the case of containing MnO₂, MnO₂ also functions as a component that absorbs visible light, and thus the content of MnO₂ is preferably set to 50 ppm or less of the total amount of the above-described glass composition. Particularly, from the viewpoint of preventing a decrease in the internal transmittance of the glass sheet at a wavelength of 400 to 700 nm, MnO₂ is preferably set to 10 ppm or less.

The glass of the glass sheet 12 of the present embodiment may also contain TiO₂. In the case of containing TiO₂, TiO₂ also functions as a component that absorbs visible light, and thus the content of TiO₂ is preferably set to 1,000 ppm or less of the total amount of the above-described glass composition. From the viewpoint of preventing a decrease in the internal transmittance of the glass sheet at a wavelength of 400 to 700 nm, the content of TiO₂ is more preferably set to 500 ppm or less and particularly preferably 100 ppm or less.

The glass of the glass sheet 12 of the present embodiment may also contain CeO₂. CeO₂ has an effect of decreasing the redox of iron and is capable of decreasing the ratio of the amount of Fe²⁻ to the total iron amount. However, in order to suppress the redox of iron being decreased to less than 3%, the content of CeO₂ is preferably set to 1,000 ppm or less of the total amount of the above-described glass composition. In addition, the content of CeO₂ is more preferably set to 500 ppm or less, still more preferably set to 400 ppm or less, particularly preferably set to 300 ppm or less, and most preferably set to 250 ppm or less.

The glass of the glass sheet 12 of the present embodiment may also contain at least one kind of component selected from the group consisting of CoO, V₂O₅ and CuO. In the case of containing these components, they also function as a component that absorbs visible light, and thus the content of the components is preferably set to 10 ppm or less of the total amount of the above-described glass composition. Particularly, these components are preferably substantially not contained so as to prevent a decrease in the internal transmittance of the glass sheet at a wavelength of 400 to 700 nm.

<Shape of Glass Sheet 12>

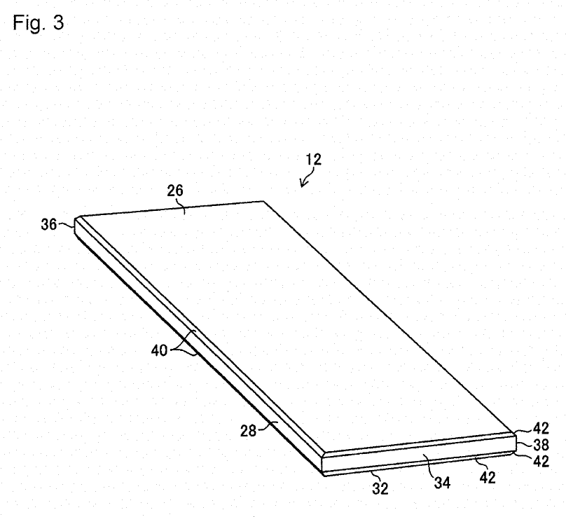

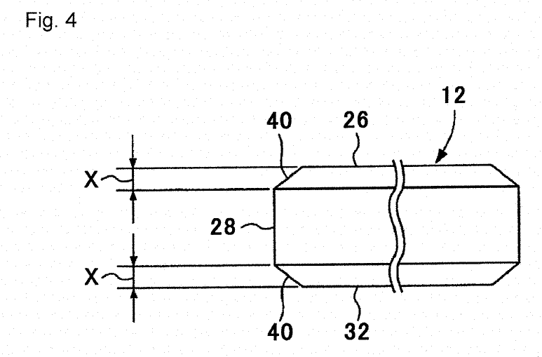

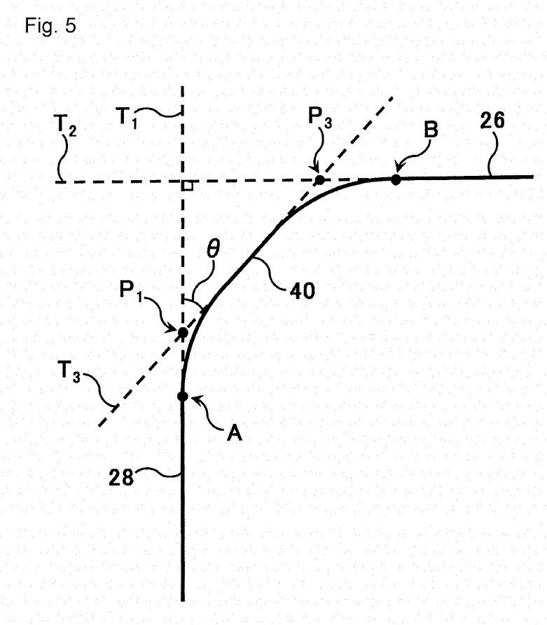

FIG. 3 is an overall perspective view of the glass sheet 12, FIG. 4 is an end surface enlarged view of the glass sheet 12, and FIGS. 5 to 7 are cross-sectional enlarged views of the glass sheet 12. FIGS. 5 to 7 illustrate a part of a cross section perpendicular to the main surface and the light entrance end surface 28 in an enlarged manner.

The glass sheet 12 having a rectangular shape in a plan view has the light emission surface 26, the light reflection surface 32, the light entrance end surface 28, the non-light entrance end surfaces 34, 36 and 38, light entrance-side chamfered surface 40, and non-light entrance-side chamfered surface 42.

Here, the light emission surface 26 and the light reflection surface 32 correspond to the main surface of the present embodiment, and the light entrance end surface 28 corresponds to the first end surface of the present embodiment. In addition, the non-light entrance end surfaces 34, 36 and 38 correspond to second end surface of the present embodiment, and the light entrance-side chamfered surface 40 corresponds to the chamfered surface of the present embodiment.

The light emission surface 26 is a surface facing the liquid crystal panel 16 (refer to FIG. 1). In the embodiment, the light emission surface 26 has a substantially rectangular shape in a plan view, but the shape of the light emission surface 26 is not limited thereto. In addition, the size of the light emission surface 26 is determined depending on the liquid crystal panel 16 and is thus not particularly limited; however, in the case where the glass sheet 12 is used as a light guide sheet, for example, a size of 300 mm×300 mm or more is preferred, and a size of 500 mm×500 mm or more is more preferred. The glass sheet 12 has a high stiffness, and thus it further exhibits the effects as the size increases.

The light reflection surface 32 is a surface facing the light emission surface 26. The light reflection surface 32 is constituted so as to become parallel to the light emission surface 26. In addition, the light reflection surface 32 is constituted so as to have a shape and a size which are substantially the same as those of the light emission surface 26.

The light reflection surface 32 does not necessarily need to be set to be parallel to the light emission surface 26 and may also be constituted to have a step or an inclination. In addition, the size of the light reflection surface 32 may also be different from the size of the light emission surface 26.

The light reflection surface 32 includes a plurality of round reflection dots 24A, 24B and 24C. The disposition of the reflection dots may be a lattice shape (grid) as in FIG. 2, an arbitrary pattern other than the lattice shape, or a random manner, and it is appropriately adjusted so that the distribution of the brightness of light emitted from the light emission surface 26 becomes uniform. Regarding the reflection dots 24A to 24C, the equivalent effect can be obtained by forming by a method of printing or the like a resin on the glass sheet 12 in a dot shape, attaching a transparent resin film on which the reflection dots 24A to 24C are printed to the glass sheet 12, mounting a transparent resin film on which the reflection dots 24A to 24C are printed on the glass sheet 12, forming grooves that reflect incident light on the light reflection surface 32 instead of the reflection dots 24A to 24C, or processing the surface of the glass sheet 12 by laser processing or chemical etching processing. The reflection dots 24A to 24C may contain scattering particles or air bubbles. The brightness of light incident on the light entrance end surface 28 is strong, but the brightness gradually weakens as the light progresses while being repeatedly reflected in the inside of the glass sheet 12.

Therefore, in the embodiment, the sizes of the reflection dots 24A, 24B and 24C are varied from the light entrance end surface 28 toward the non-light entrance end surface 38. Specifically, a diameter (L_{A}) of the reflection dot 24A in a region close to the light entrance end surface 28 is set to be small, and a diameter (L_{B}) of the reflection dot 24B and a diameter (L_{C}) of the reflection dot 24C are set to increase in a progress direction of light (L_{A}<L_{B}<L_{C}). The diameters of the reflection dots are appropriately adjusted so that the distribution of the brightness of light emitted from the light emission surface 26 becomes uniform.

By changing the sizes of the reflection dots 24A, 24B and 24C in the progress direction of light inside the glass sheet 12 as described above, it is possible to make the brightness of emitted light emitted from the light emission surface 26 uniform and suppress the generation of brightness unevenness. Meanwhile, even by changing the number densities of the reflection dots 24A, 24B and 24C in the progress direction of light inside the glass sheet 12 instead of the sizes of the reflection dots 24A, 24B and 24C, the equivalent effect can be obtained. In addition, even when grooves that reflect incident light are formed on the light reflection surface 32 instead of the reflection dots 24A, 24B and 24C, the equivalent effect can be obtained.

Light from the light source 18 is not caused to enter the non-light entrance end surfaces 34, 36 and 38 of the glass sheet 12, and thus the surfaces of the non-light entrance end surfaces may not be processed as highly accurately as that of the light entrance end surface 28, but the arithmetic average roughness Ra of the non-light entrance end surfaces 34, 36 and 38 may be equivalent to or less than the arithmetic average roughness Ra of the light entrance end surface 28. In this case, the surface roughness Ra of the non-light entrance end surfaces 34, 36 and 38 is set to 0.8 μm or less. However, in order to suppress the scattering of light at the end surface and the consequent generation of brightness unevenness, the surface roughness Ra of the non-light entrance end surfaces 34, 36 and 38 is preferably 0.4 μm or less, more preferably 0.2 μm or less, and still more preferably 0.1 μm or less. In the present specification, the case of describing the surface roughness Ra refers to the arithmetic average roughness (center line average roughness) according to JIS B 0601 to JIS B 0031.

The light entrance end surface 28 may be polished by using a polishing tool during the manufacturing of the glass that is the glass sheet 12. The surface roughness Ra of the light entrance end surface 28 is 0.1 μm or less in order to cause light from the light source 18 to effectively enter the inside of the glass sheet 12, preferably less than 0.03 μm, more preferably 0.01 μm or less, and particularly preferably 0.005 μm or less. In such a case, the light entrance efficiency of light caused to enter the inside of the glass sheet 12 from the light source 18 is increased. The surface roughness Ra of the non-light entrance end surfaces 34, 36 and 38 may be set to be larger than the surface roughness Ra of the light entrance end surface 28 from the viewpoint of improving the production efficiency or may be equivalent to the surface roughness Ra of the light entrance end surface 28 so that the non-light entrance end surfaces 34, 36 and 38 can be handled in the same manner as the light entrance end surface 28.

The light entrance-side chamfered surface 40 adjacent to the light emission surface 26 is provided between the light emission surface 26 and the light entrance end surface 28. Similarly, the light entrance-side chamfered surface 40 adjacent to the light reflection surface 32 is provided between the light reflection surface 32 and the light entrance end surface 28.

In the present embodiment, the one including the light entrance-side chamfered surfaces 40 on both the light emission surface 26 side and the light reflection surface 32 side is exemplified, but a constitution including the light entrance-side chamfered surface 40 only on any one side may be employed. In addition, the surface roughness Ra of the light entrance-side chamfered surface 40 is 0.8 μm or less, preferably 0.5 μm or less, more preferably 0.1 μm or less, still more preferably 0.05 μm or less, and most preferably less than 0.03 μm. By setting the surface roughness Ra of the light entrance-side chamfered surface 40 to 0.1 μm or less, it is possible to suppress the generation of the brightness unevenness of light emitted from the glass sheet 12. In addition, it is also possible to suppress the generation of scattered light in inspection steps and improve the measurement accuracy of the surface conditions of the light entrance end surface 28 and the light entrance-side chamfered surface 40.

From the viewpoint of improving the production efficiency, the surface roughness Ra of the light entrance end surface 28 is preferably smaller than that of the light entrance-side chamfered surface 40 (Ra of the light entrance end surface 28<Ra of the light entrance-side chamfered surface 40), but the surface roughness Ra of the light entrance end surface 28 and the surface roughness Ra of the light entrance-side chamfered surface 40 may be equivalent to each other. Regarding the non-light entrance end surfaces 34, 36 and 38, surfaces on which a cutting treatment has been carried out may be used as the non-light entrance end surfaces 34, 36 and 38 as they are.

When the width dimension of the light entrance-side chamfered surface 40 is represented by X (mm) as illustrated in FIG. 4, an average value Xₐᵥₑ of these width dimensions X in a chamfered surface longitudinal direction (hereinafter, simply referred to as the longitudinal direction) is preferably 0.1 mm to 0.5 mm. In the case where Xₐᵥₑ is 0.5 mm or less, it is possible to increase the width dimension of the light entrance-side chamfered surface 40. When Xₐᵥₑ is 0.1 mm or more, it is possible to decrease an error of X described below.

In the width dimension X of the light entrance-side chamfered surface 40, an error attributed to process unevenness during chamfering is actually generated in the longitudinal direction. As described above, in the case where the average value in the longitudinal direction of the width dimensions X of the light entrance-side chamfered surfaces 40 is represented by Xₐᵥₑ (mm), the error in the longitudinal direction of X is preferably within 50% of Xₐᵥₑ. That is, X satisfies 0.5Xₐᵥₑ≤X≤1.5Xₐᵥₑ. It is more preferably within 40%, more preferably within 30%, and particularly preferably within 20%. In such a case, the errors of the width dimension of the light entrance-side chamfered surface 40 and the width dimension of the light entrance end surface 28, in the longitudinal direction, become small, and thus it is possible to decrease brightness unevenness that is generated in the planar light emitting device 14.

In the planar light emitting device 14 requiring thickness reduction as in the present embodiment, it is also necessary to reduce the thickness of the glass sheet 12. Therefore, the thickness of the glass sheet 12 according to the present embodiment is, for example, 0.7 to 3.0 mm. In the case where the thickness of the glass sheet 12 is 3.0 mm or less, the planar light emitting device 14 can be thinned, and, in the case of 0.7 mm or more, a sufficient stiffness can be obtained. The thickness of the glass sheet 12 is not limited to this value; however, in the case of this thickness, it is possible to provide the planar light emitting device 14 having a sufficient strength compared with planar light emitting devices having an acrylic light guide sheet having a thickness of 4 mm or more.

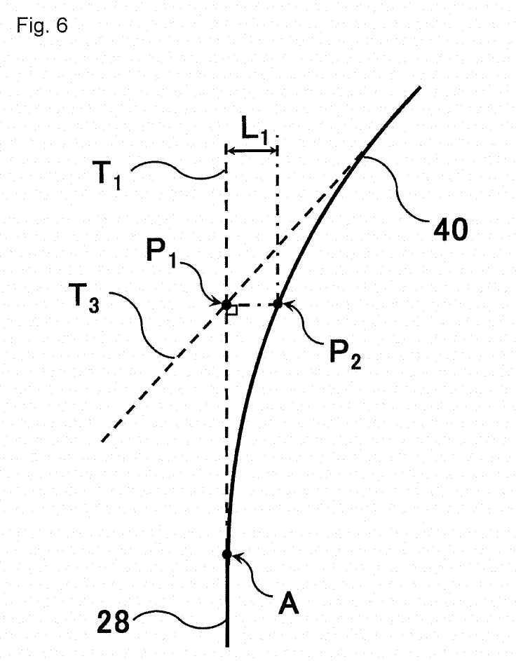

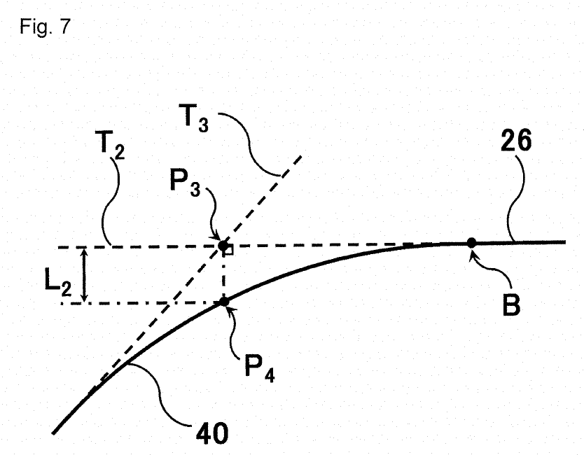

Next, description will be made on the basis of FIGS. 5 to 7. FIG. 5 is an explanatory view illustrating a characteristic of the glass sheet 12 in an enlarged manner and a cross-sectional view perpendicular to the light emission surface 26 which is the main surface, the light reflection surface 32, and the light entrance end surface 28 which is the first end surface. FIG. 6 is an explanatory view illustrating a vicinity of a boundary between the light entrance end surface 28 and the light entrance-side chamfered surface 40 of the glass sheet 12 in a particularly enlarged manner. FIG. 7 is an explanatory view illustrating a vicinity of a boundary between the light emission surface 26 and the light entrance-side chamfered surface 40 of the glass sheet 12 in a particularly enlarged manner.

Although FIG. 1 illustrates the light entrance end surface 28 and the light emission surface 26 having a straight-line shape, in actual cases, the shape of the light entrance end surface 28 and the light emission surface 26 is a straight-line shape or a curved shape. Among end surfaces and main surfaces of glass of the related art as well, there are end surfaces and main surfaces which have a curved shape in actual cases while being designed to have a straight-line shape.

Therefore, in a cross section perpendicular to the light emission surface 26 and the light entrance end surface 28, a straight line obtained by approximating the curved line of the light entrance end surface 28 or the light emission surface 26 by the least square method is considered as an imaginary line T₁ of the light entrance end surface 28 or an imaginary line T₂ of the light emission surface 26 respectively, as illustrated in FIGS. 5 to 7.

In addition, similarly, the light entrance-side chamfered surface 40 also has a straight-line shape or a curved shape in actual cases as illustrated in FIGS. 5 to 7. Among chamfered surfaces of glass of the related art as well, there are chamfered surfaces which have a curved shape in actual cases while being designed to have a straight-line shape.

Therefore, in a cross section perpendicular to the light emission surface 26 and the light entrance end surface 28, a tangent line which is in contact with the light entrance-side chamfered surface 40 and is a tangent line at a point at which the contact length becomes longest is considered as an imaginary line T₃ of the light entrance-side chamfered surface 40.

The glass sheet 12 of the present embodiment includes the light entrance-side chamfered surface 40 for which, in the cross section perpendicular to the light emission surface 26 and the light entrance end surface 28, the imaginary line 13 of the light entrance-side chamfered surface 40, which is the tangent line being in contact with the light entrance-side chamfered surface 40 and which is the tangent line at a point at which the contact length becomes longest, has a predetermined inclination angle θ with respect to the imaginary line T₁. The inclination angle θ is not particularly limited, but θ is preferably 30° to 60° and more preferably 40° to 50° in order to effectively suppress the breakage of the glass. In addition, in order to effectively use the light quantity of the light source without being lost, θ preferably satisfies 0.01≤tan θ≤0.75.

In the cross section perpendicular to the light emission surface 26 and the light entrance end surface 28, in the case where a straight line which passes through a first intersection point P₁, at which the imaginary line T₁ of the light entrance end surface 28 and the imaginary line 13 of the light entrance-side chamfered surface 40 intersect, and is perpendicular to the imaginary line T₁ is extended toward the light entrance-side chamfered surface 40, a point at which the straight line and the light entrance-side chamfered surface 40 intersects (the foot of the perpendicular line) is considered as a second intersection point P₂. The length of a line segment L₁ connecting the first intersection point P₁ and the second intersection point P₂ is 10 μm or less. In such a case, it is possible to decrease the quantity of light being scattered in the vicinity of the boundary between the light entrance end surface 28 and the light entrance-side chamfered surface 40 in inspection steps and improve the measurement accuracy of the dimensions of the light entrance end surface 28. In the case where both the light entrance end surface 28 and the light entrance-side chamfered surface 40 have an ideal straight-line shape, the first intersection point P₁ and the second intersection point P₂ coincide with each other, and the length of the line segment L₁ is 0 μm. The length of the line segment L₁ is preferably 7 μm or less, more preferably 5 μm or less, 3 μm or less, or 1 μm or less. From the viewpoint of improving the mechanical strength and the productivity, the length of the line segment L₁ is preferably 0.1 μm or more.

In addition, in the cross section perpendicular to the light emission surface 26 and the light entrance end surface 28, a curvature radius R₁ of the light entrance-side chamfered surface 40 at the second intersection point P₂ is 110 μm or less. In such a case, it is possible to decrease the quantity of light being scattered in the vicinity of the boundary between the light entrance end surface 28 and the light entrance-side chamfered surface 40 in inspection steps and improve the measurement accuracy of the dimensions of the light entrance end surface 28. In the case where both the light entrance end surface 28 and the light entrance-side chamfered surface 40 have an ideal straight-line shape, a fourth intersection point is a point having no curvature, and the curvature radius R₁ is considered as 0 μm. The curvature radius R₁ is preferably 77 μm or less and more preferably 55 μm or less, 33 μm or less, or 11 μm or less. From the viewpoint of improving the mechanical strength and the productivity, the curvature radius R₁ is preferably 1 μm or more.

In the cross section perpendicular to the light emission surface 26 and the light entrance end surface 28, in the case where a straight line which passes through a third intersection point P₃, at which the imaginary line T₂ of the light emission surface 26 and the imaginary line T₃ of the light entrance-side chamfered surface 40 intersect, and is perpendicular to the imaginary line T₂ is extended toward the light entrance-side chamfered surface 40, a point at which the straight line and the light entrance-side chamfered surface 40 intersects (the foot of the perpendicular line) is considered as a fourth intersection point P₄. The length of a line segment L₂ connecting the third intersection point P₃ and the fourth intersection point P₄ is preferably 10 μin or less. In such a case, it is possible to decrease the quantity of light being scattered in the vicinity of the boundary between the light emission surface 26 and the light entrance-side chamfered surface 40 in inspection steps and improve the measurement accuracy of the dimensions of the light entrance-side chamfered surface 40. In the case where both the light emission surface 26 and the light entrance-side chamfered surface 40 have an ideal straight-line shape, the third intersection point P₃ and the fourth intersection point P₄ coincide with each other, and the length of the line segment L₂ is 0 μm. The length of the line segment L₂ is preferably 7 μm or less, more preferably 5 μm or less, 3 μm or less, or 1 μm or less. From the viewpoint of improving the mechanical strength and the productivity, the length of the line segment L₂ is preferably 0.1 μm or more.

In addition, in the cross section perpendicular to the light emission surface 26 and the light entrance end surface 28, a curvature radius R₂ of the light entrance-side chamfered surface 40 at the fourth intersection point P₄ is preferably 110 μm or less. In such a case, it is possible to decrease the quantity of light being scattered in the vicinity of the boundary between the light emission surface 26 and the light entrance-side chamfered surface 40 in inspection steps and improve the measurement accuracy of the dimensions of the light entrance-side chamfered surface 40. In the case where all of the light emission surface 26, the light entrance end surface 28 and the light entrance-side chamfered surface 40 have an ideal straight-line shape, the fourth intersection point is a point having no curvature, and the curvature radius R₂ is considered as 0 μm. The curvature radius R₂ is preferably 77 μm or less and more preferably 55 μm or less, 33 μm or less, or 11 μm or less. From the viewpoint of improving the mechanical strength and the productivity, the curvature radius R₂ is preferably 1 μm or more.

All of the above-described characteristics of the shape of the glass sheet 12 in the cross section perpendicular to the light emission surface 26 and the light entrance end surface 28 can be measured and evaluated by the following procedure by using an image dimension measuring system IM-6120 manufactured by Keyence Corporation. The present measuring method can be used only in off-line inspection and is suitable particularly for highly accurate shape evaluation.

1; A light shielding film is provided to the cross section perpendicular to the light emission surface 26 and the light entrance end surface 28 of the glass sheet 12 so as to cover only the full surface of the cross section.

2; The glass sheet 12 is mounted on a stage so that the cross section perpendicular to the light emission surface 26 and the light entrance end surface 28 becomes horizontal.

3; The sheet thickness of the glass sheet 12 is measured from the contour of the cross section perpendicular to the light emission surface 26 and the light entrance end surface 28 of the glass sheet 12 in the “line-line” mode of the “basic measurement” tab. The contour can be recognized as a boundary between black and white in an image. In the “line-line” mode, two arbitrary points are manually selected on each of straight lines corresponding to the light emission surface 26 and the light reflection surface 32 in the contour, whereby approximate straight lines of the light emission surface 26 and the light reflection surface 32 are automatically obtained, and the sheet thickness can be measured.

4; The above-described line segments L₁ and L₂ or the curvature radii R₁ and R₂ are evaluated on the basis of the contour of the cross section perpendicular to the light emission surface 26 and the light entrance end surface 28 of the glass sheet 12 and the measured sheet thickness.

[Method for Manufacturing Glass Sheet 12]

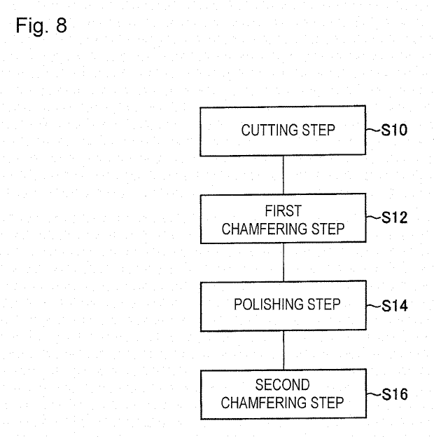

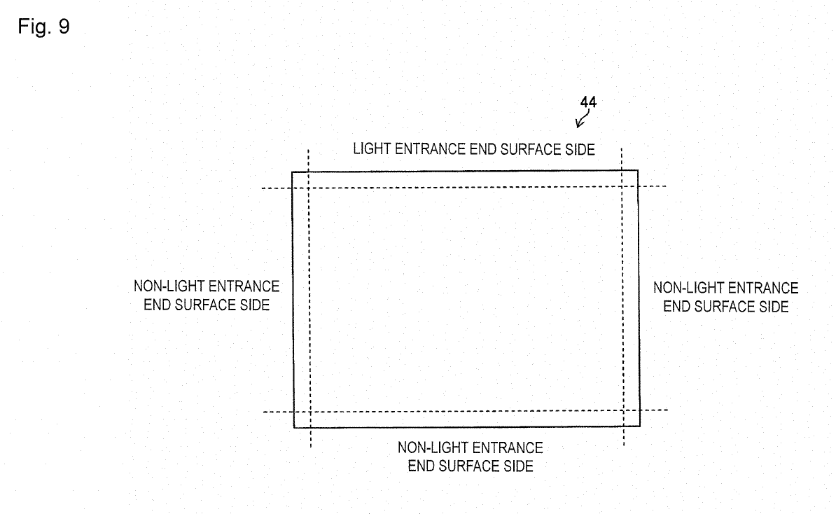

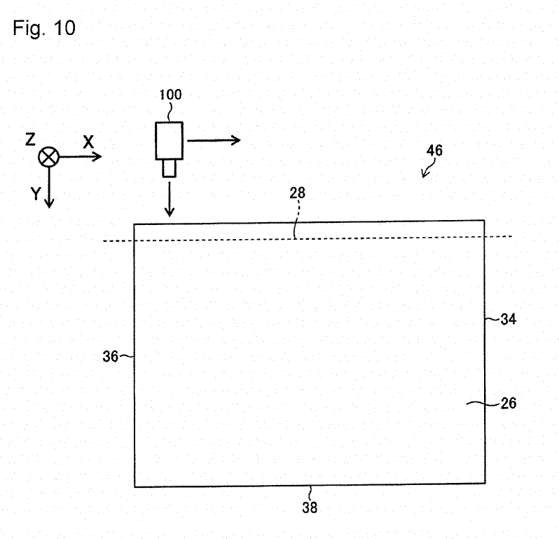

FIGS. 8 to 10 are views for describing a method for manufacturing the glass sheet 12. FIG. 8 is a step view of the method for manufacturing the glass sheet 12. FIG. 9 is a plan view of a glass material 44, and FIG. 10 is a plan view of a glass base material 46.

In order to manufacture the glass sheet 12, first, the glass material 44 of FIG. 9 is prepared. The thickness of the glass material is 0.7 to 3.0 mm, and the average internal transmittance is 90% or more at a light path length of 50 mm and a wavelength of 400 to 700 nm. The glass material 44 is provided with a shape that is larger than or equal to the predetermined shape of the glass sheet 12.

<Cutting Step>

On the glass material 44, first, a cutting step illustrated in a step (S10) of FIG. 8 is carried out. In the cutting step (S10), cutting is carried out on at least one portion of individual locations indicated by broken lines in FIG. 9 (one location on the light entrance end surface side and three locations on the non-light entrance end surface sides) by using a cutting device. Cutting may not be necessarily carried out on any of one location on the light entrance end surface side and three locations on the non-light entrance end surface sides, or the shape of the glass material 44 may be used as it is without carrying out cutting on any of the locations.

When cutting is carried out, the glass base material 46 of FIG. 10 is cut out from the glass material 44 of FIG. 9. In the embodiment, the glass sheet 12 has a rectangular shape in a plan view, and thus cutting is carried out on one location on the light entrance end surface side and three locations on the non-light entrance end surface sides, but cutting locations are appropriately selected depending on the shape of the glass sheet 12.

<First Chamfering Step>

When the cutting step (S10) ends, a first chamfering step (S12) may be carried out as illustrated in FIG. 8. In the first chamfering step (S12), a portion between the light emission surface 26 and the light entrance end surface 28 and a portion between the light reflection surface 32 and the light entrance end surface 28 are chamfered by using a grinding device. Therefore, a light entrance-side chamfered surface 40′ (not illustrated) is formed. In addition, in the first chamfering step (S12), a portion between the light emission surface 26 and the non-light entrance end surface 38 and a portion between the light reflection surface 32 and the non-light entrance end surface 38 are chamfered, whereby the non-light entrance-side chamfered surfaces 42 are respectively formed.

In the case where the non-light entrance-side chamfered surface(s) 42 is formed at all or one of a portion between the light emission surface 26 and the non-light entrance end surface 34, a portion between the light reflection surface 32 and the non-light entrance end surface 34, a portion between the light emission surface 26 and the non-light entrance end surface 36, and the portion between the light reflection surface 32 and the non-light entrance end surface 36, chamfering may be carried out in the first chamfering step (S12).

In the first chamfering step (S12), a grinding treatment or a polishing treatment may be carried out on the non-light entrance end surfaces 34, 36 and 38. The period of carrying out the grinding treatment or the polishing treatment on the non-light entrance end surfaces 34, 36 and 38 may be before, after or at the same time as the formation of the non-light entrance-side chamfered surface 42. Regarding the non-light entrance end surfaces 34, 36 and 38 and the light entrance end surface 28, the surfaces on which cutting is carried out may be used as the non-light entrance end surfaces 34, 36 and 38 and the light entrance end surface 28 as they are.

The first chamfering step (S12) can be carried out at the same time as a polishing step (S14) described below, but is preferably carried out before the polishing step (S14). That is, the polishing step (S14) is preferably carried out after the first chamfering step (S12). In such a case, a processing according to the shape of the glass sheet 12 can be carried out in the first chamfering step (S12) at a relatively fast rate, and thus the productivity improves. In the case where the surfaces on which the cutting process is carried out are used as the non-light entrance end surfaces 34, 36 and 38 and the light entrance end surface 28 as they are, the polishing step as described below may not be carried out.

<Polishing Step>

When the first chamfering step (S12) ends, next, the polishing step (S14) may be carried out. In the polishing step (S14), mirror-finishing is carried out on the light entrance end surface 28 of the glass base material 46 illustrated in FIG. 10, whereby the light entrance end surface 28 is formed.

As a polishing tool used to form the light entrance end surface 28, a grinding stone may be used, and, other than the grinding stone, a buff made of cloth, rind, rubber, or the like, a brush, or the like may also be used. At this time, a polishing agent such as cerium oxide, alumina, carborundum, or colloidal silica may also be used. Among these, from the viewpoint of decreasing the surface roughness, a buff and a polishing agent are preferably used as the polishing tool.

<Second Chamfering Step>

When the polishing step (S14) ends, next, a second chamfering step (S16) may be carried out as necessary. In the second chamfering step (S16), chamfering is carried out again on the light entrance-side chamfered surface 40′ of the glass base material 46 which is formed in the first chamfering step (S12), and thus, preferably, the light entrance-side chamfered surface 40 in which the length of the line segment L₁ connecting the first intersection point P₁ and the second intersection point P₂ is 10 μm or less is formed.

As a polishing tool used to form the light entrance-side chamfered surface 40, one having a high hardness is preferably used. Particularly, a resin bond grinding stone or a rubber grinding stone is preferred. Abrasive grains preferably include any one selected from the group consisting of diamond, alumina, carborundum, and cerium oxide. Additionally, other than the grinding stone, a buff which is made of cloth, rind, rubber, or the like and has a Shore A hardness of 80 or more may be used, and, at this time, a polishing agent such as cerium oxide, alumina, carborundum, or colloidal silica may also be used. Particularly, from the viewpoint of decreasing the surface roughness and the length of the line segment L₂, a resin bond grinding stone or a rubber grinding stone having a grain size indication of #170 or more is preferably used as the polishing tool.

Through each of the steps described in S10 to S16 above, the glass sheet 12 is manufactured. The reflection dots 24A, 24B and 24C may be formed on the light reflection surface 32 by a method such as printing after the manufacturing of the glass sheet 12, or each of the steps described in S10 to S16 above may be carried out after the formation of the reflection dots 24A, 24B and 24C.

The method for manufacturing the glass sheet 12 of the present embodiment is not limited to the above-described one. For example, in the case where the length of the line segment L₁ of the light entrance-side chamfered surface 40′ obtained in the first chamfering step (S12) is 10 μm or less, it is possible to skip the second chamfering step (S16). In addition, in the case of a method in which a light entrance-side chamfered surface having a length of the line segment L₁ of 10 μm or less and a light entrance end surface having a surface roughness Ra of 0.1 μm or less can be formed in the cutting step (S10), it is possible to skip all of the first chamfering step (S12), the polishing step (S14) and the second chamfering step (S16).

<Inspection Step>

After the glass sheet 12 is manufactured through each of the steps described in S10 to S16 above, an inspection step is preferably carried out. In the inspection step, the end surface property (dimensions and the surface condition) of, particularly, the light entrance end surface 28 and the light entrance-side chamfered surface 40 of the glass sheet 12 is measured by using an inspection device 100. In the inspection step, on-line inspection (one hundred percent inspection) is preferably carried out, and, as the inspection device 100, an optical measurement device is preferably used. In such a case, it is possible to measure the entire light entrance end surface 28 at a high speed and a high accuracy in a non-destructive manner.

A light-receiving surface (not illustrated) of the inspection device 100 is preferably disposed in a Y direction illustrated in FIG. 10, that is, a direction facing the light entrance end surface 28. In such a case, it is possible to measure the end surface property of the light entrance end surface 28 and the light entrance-side chamfered surface 40 at the same time. By moving the inspection device parallel to an X direction or moving the glass sheet 12 parallel to the X direction, the inspection device 100 is capable of measuring the entire surfaces of the light entrance end surface 28 and the light entrance-side chamfered surface 40 in a non-destructive manner.

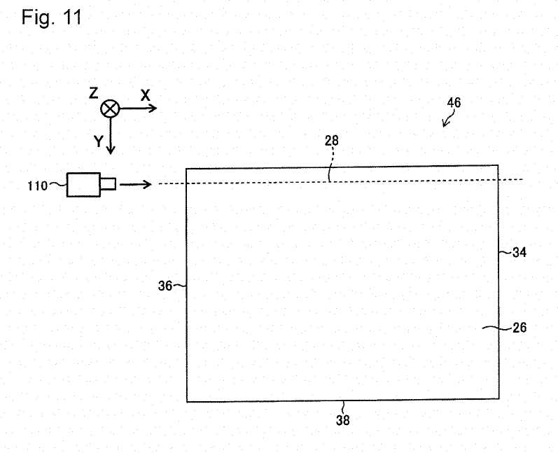

On the other hand, in the case where a light-receiving surface of an inspection device 110 is disposed in a direction facing the non-light entrance end surface 36 as illustrated in FIG. 11, the accuracy is high, but it is not possible to measure the entire surfaces of the light entrance end surface 28 and the light entrance-side chamfered surface 40 in a non-destructive manner. The above-described method is effective in, for example, off-line inspection (sample inspection), but is not applicable to on-line inspection since it is necessary to destruct products in order for highly accurate measurement.

In the case where only the light entrance-side chamfered surface 40 is measured, the light-receiving surface may be disposed in a Z direction illustrated in FIG. 10, that is, a direction facing the light emission surface 26.

The glass sheet 12 of the present embodiment has an end surface property that can be measured at a sufficiently high accuracy in the inspection step throughout the entire surfaces of the light entrance end surface 28 and the light entrance-side chamfered surface 40. Therefore, it becomes possible to measure errors of the width dimensions in the longitudinal direction of the light entrance end surface 28 and the light entrance-side chamfered surface 40.

Hitherto, a preferred embodiment of the present invention has been described in detail, but the present invention is not limited to the above-described specific embodiment and can be modified or changed in various manners within the scope of the gist of the present invention described in the claims.

### EXAMPLES

Hereinafter, the present invention will be specifically described using Examples and the like, but the present invention is not limited to these examples.

In Experiments 1 and 2 below, as a glass sheet, a glass sheet (height: 700 mm, width: 700 mm and sheet thickness: 1.8 mm) including, in terms of mass percentage, 71.6% of SiO₂, 0.97% of Al₂O₃, 3.6% of MgO, 9.3% of CaO, 13.9% of Na₂O, 0.05% of K₂O, and 0.005% of Fe₂O₃ was used. The glass sheet was one obtained by being cut out in a cutting step from a glass sheet manufactured by a floating method. (During the cutting, corner portions of the glass sheet were cut in order to prevent cracking.) The glass sheet has four end surfaces between a light emission surface and a light reflection surface, and, among the four end surfaces, one end surface is a light entrance end surface, and three end surfaces are non-light entrance end surfaces.

After a cutting treatment, a first chamfering step was carried out. In the first chamfering step, a grinding treatment was carried out on the three non-light entrance end surfaces. After that, mirror-finishing was carried out on the light entrance end surface by using a polishing device under a variety of conditions. Furthermore, portions between the light emission surface and the non-light entrance end surfaces, portions between the light reflection surface and the non-light entrance end surfaces, a portion between the light emission surface and the light entrance end surface, and a portion between the light reflection surface and the light entrance end surface of the glass sheet were chamfered by using a grinding device. After that, a polishing step was carried out, and the light entrance end surface was polished so that Ra reached 0.01 μm.

(Experiment 1)

After the polishing, a second chamfering step was carried out. In the second chamfering step, the portion between the light emission surface and the light entrance end surface and the portion between the light reflection surface and the light entrance end surface which had been ground in the first chamfering step were again chamfered by a resin bond grinding stone including diamond abrasive grains having a grain size indication of #1,500. Thus, a light entrance-side chamfered surface was obtained.

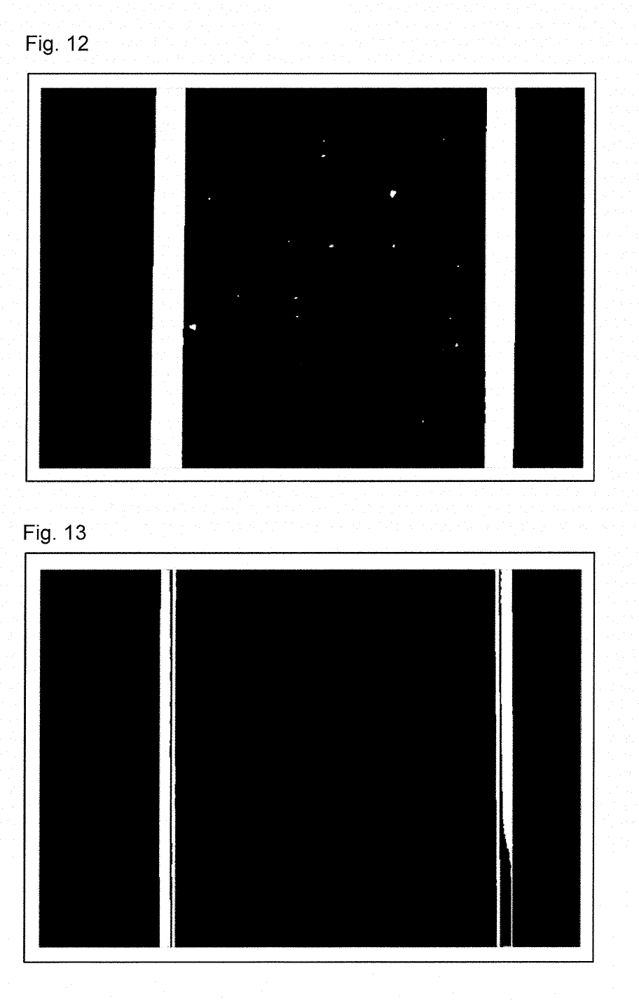

An enlarged view of the light entrance end surface of the glass sheet obtained in the above-described manner is illustrated in FIG. 12. In a cross section perpendicular to the light emission surface and the light entrance end surface of the glass sheet, in the case where a point at which an imaginary line of the light entrance end surface and an imaginary line of the light entrance-side chamfered surface intersected was considered as a first intersection point, and a point at which a straight line that passed through the first intersection point, was perpendicular to the imaginary line of the light entrance end surface and is extended toward the light entrance-side chamfered surface intersected the light entrance-side chamfered surface was considered as a second intersection point, a length L₁ of a line segment connecting the first intersection point and the second intersection point was measured by using an image dimension measuring system IM-6120 manufactured by Keyence Corporation and was found to be 3 μm. In addition, similarly, a curvature radius R₁ of the chamfered surface at the second intersection point was measured and was found to be 34 μm.

Furthermore, in a cross section perpendicular to the light emission surface and the light entrance end surface of the glass sheet, in the case where a point at which an imaginary line of the light emission surface and an imaginary line of the light entrance-side chamfered surface intersected was considered as a third intersection point, and a point at which a straight line that passed through the third intersection point, was perpendicular to the imaginary line of the light emission surface and is extended toward the light entrance-side chamfered surface intersected the light entrance-side chamfered surface was considered as a fourth intersection point, a length L₂ of a line segment connecting the third intersection point and the fourth intersection point was measured by using the image dimension measuring system IM-6120 manufactured by Keyence Corporation and was found to be 4.2 μm. In addition, similarly, a curvature radius R₂ of the chamfered surface at the fourth intersection point was measured and was found to be 51 μm.

For this glass sheet, a width dimension W of the light entrance end surface was measured by using the image dimension measuring system IM-6120 manufactured by Keyence Corporation and was found to be 1,495 μm. On the other hand, the width dimension W was measured by using a Microscope VHX-2000 manufactured by Keyence Corporation, simulating on-line inspection, and was found to be 1,501 μm. Therefore, a dimensional error between the two measurement devices was approximately 0.4%.

(Experiment 2)

Subsequently, after the polishing, the same evaluations were carried out on a glass sheet for which the second chamfering step was not carried out.

An enlarged view of a light entrance end surface of this glass sheet is illustrated in FIG. 13. For this glass sheet, similarly, a length L₁ of a line segment connecting a first intersection point and a second intersection point was measured by using the image dimension measuring system IM-6120 manufactured by Keyence Corporation and was found to be 32 μm In addition, a curvature radius R₁ of a chamfered surface at the second intersection point was measured and was found to be 340 μm.

Furthermore, a length L₂ of a line segment connecting a third intersection point and a fourth intersection point of this glass sheet was measured by using the image dimension measuring system IM-6120 manufactured by Keyence Corporation and was found to be 33 μm. In addition, similarly, a curvature radius R₂ of a chamfered surface at the fourth intersection point was measured and was found to be 400 μm.

For this glass sheet, a width dimension W of the light entrance end surface was measured by using the image dimension measuring system IM-6120 manufactured by Keyence Corporation and was found to be 973 μm. On the other hand, the width dimension W was measured by using a Microscope VHX-2000 manufactured by Keyence Corporation which was similar measurement device as those that can be used in on-line inspection and was found to be 1,611 μm. Therefore, a dimensional error between the two measurement devices was approximately 66%.

FIGS. 12 and 13 are images of the glass sheets obtained in Experiments 1 and 2 taken by using the Microscope VHX-2000 manufactured by Keyence Corporation. Photographing was carried out by the Microscope in a condition in which the light-receiving surface was disposed in the Y direction illustrated in FIG. 10, that is, the direction facing the light entrance end surface in the same manner as in on-line inspection.

Here, a branching point A between the light entrance end surface 28 and the light entrance-side chamfered surface 40 is a point which is on the light entrance end surface 28 and on the imaginary line T₁ and is determined so that a contact length with the light entrance end surface 28 becomes longest. The branching point A has two branching points of a branching point with the light entrance-side chamfered surface 40 and a branching point with the non-light entrance-side chamfered surface 42. A line segment connecting the branching point with the light entrance-side chamfered surface 40 and the branching point with the non-light entrance-side chamfered surface 42 is considered as a width dimension W of the light entrance end surface.

In the image of FIG. 12, the location of the branching point A can be clearly determined from the black and white (contrast) of the image, and the width dimension W of the light entrance end surface can be measured at a high accuracy. On the other hand, in the image of FIG. 13, the location of the branching point A is not clear from the contrast of the image, and it is found that the measurement accuracy of the width dimension W becomes poor.

From Experiments 1 and 2, it was found that, in order to obtain a dimensional error of approximately 1% or less, it is necessary to set the length L₁ of the line segment connecting the first intersection point and the second intersection point to 10 μm or less and set the curvature radius R₁ of the chamfered surface at the second intersection point to 110 μm.

Furthermore, the present invention is not limited to the above-described embodiment and can be appropriately modified, improved, or the like. Additionally, the materials, shapes, dimensions, numerical values, forms, numbers, disposition places, and the like of each of the constituent elements in the above-described embodiment are arbitrary as long as the present invention can be achieved and are not limited.

The present application is based on a Japanese patent application No. 2015-161585 filed on Aug. 19, 2015, the contents thereof being incorporated herein by reference.

### REFERENCE SIGNS LIST

10 - - - LIQUID CRYSTAL DISPLAY DEVICE, 12 - - - GLASS SHEET, 14 - - - PLANAR LIGHT EMITTING DEVICE, 16 - - - LIQUID CRYSTAL PANEL, 18 - - - LIGHT SOURCE, 20 - - - REFLECTION SHEET, 22 - - - A VARIETY OF OPTICAL SHEET, 24A, 24B, 24C - - - REFLECTION DOT, 26 - - - LIGHT EMISSION SURFACE, 28 - - - LIGHT ENTRANCE END SURFACE, 30 - - - REFLECTOR, 32 - - - LIGHT REFLECTION SURFACE, 34, 36, 38 - - - NON-LIGHT ENTRANCE END SURFACE, 40 - - - LIGHT ENTRANCE-SIDE CHAMFERED SURFACE, 42 - - - NON-LIGHT ENTRANCE-SIDE CHAMFERED SURFACE, 44 - - - GLASS MATERIAL, 46 - - - GLASS BASE MATERIAL, 100, 110 - - - INSPECTION DEVICE

1. A glass sheet comprising: a main surface; a first end surface perpendicular to the main surface; and a chamfered surface provided adjacent to the main surface and between the main surface and the first end surface, wherein,
in a cross section perpendicular to the main surface and the first end surface,
in the case where a point at which an imaginary line of the first end surface and an imaginary line of the chamfered surface intersect is a first intersection point, and a point at which a straight line that passes through the first intersection point, is perpendicular to the imaginary line of the first end surface and is extended toward the chamfered surface intersects the chamfered surface is a second intersection point, a line segment connecting the first intersection point and the second intersection point has a length of 10 μm or less.

2. A glass sheet comprising: a main surface; a first end surface perpendicular to the main surface; and a chamfered surface provided adjacent to the main surface and between the main surface and the first end surface, wherein,
in a cross section perpendicular to the main surface and the first end surface,
in the case where a point at which an imaginary line of the first end surface and an imaginary line of the chamfered surface intersect is a first intersection point, and a point at which a straight line that passes through the first intersection point, is perpendicular to the imaginary line of the first end surface and is extended toward the chamfered surface intersects the chamfered surface is a second intersection point, the chamfered surface at the second intersection point has a curvature radius of 110 μm or less.

3. The glass sheet according to claim 1, wherein,
in the cross section perpendicular to the main surface and the first end surface,
in the case where a point at which an imaginary line of the main surface and the imaginary line of the chamfered surface intersect is a third intersection point, and a point at which a straight line that passes through the third intersection point, is perpendicular to the imaginary line of the main surface and is extended toward the chamfered surface intersects the chamfered surface is a fourth intersection point, a line segment connecting the third intersection point and the fourth intersection point has a length of 10 μm or less.

4. The glass sheet according to claim 1, wherein,
in the cross section perpendicular to the main surface and the first end surface,
in the case where a point at which an imaginary line of the main surface and the imaginary line of the chamfered surface intersect is a third intersection point, and a point at which a straight line that passes through the third intersection point, is perpendicular to the imaginary line of the main surface and is extended toward the chamfered surface intersects the chamfered surface is a fourth intersection point, the chamfered surface at the fourth intersection point has a curvature radius of 110 μm or less.

5. The glass sheet according to claim 1, wherein,
in the cross section perpendicular to the main surface and the first end surface,
the imaginary line of the chamfered surface is inclined with respect to the imaginary line of the first end surface at an inclination angle θ, and the inclination angle is 30° to 60°.

6. The glass sheet according to claim 1, wherein the first end surface has a surface roughness Ra of 0.1 μm or less.

7. The glass sheet according to claim 1, wherein the glass sheet has an average internal transmittance of 90% or more at a light path length of 50 mm and a wavelength of 400 to 700 nm.

8. The glass sheet according to claim 1, wherein a surface roughness Ra of the chamfered surface is equal to or more than a surface roughness Ra of the first end surface.

9. The glass sheet according to claim 2, wherein,
in the cross section perpendicular to the main surface and the first end surface,
in the case where a point at which an imaginary line of the main surface and the imaginary line of the chamfered surface intersect is a third intersection point, and a point at which a straight line that passes through the third intersection point, is perpendicular to the imaginary line of the main surface and is extended toward the chamfered surface intersects the chamfered surface is a fourth intersection point, a line segment connecting the third intersection point and the fourth intersection point has a length of 10 μm or less.

10. The glass sheet according to claim 2, wherein,
in the cross section perpendicular to the main surface and the first end surface,
in the case where a point at which an imaginary line of the main surface and the imaginary line of the chamfered surface intersect is a third intersection point, and a point at which a straight line that passes through the third intersection point, is perpendicular to the imaginary line of the main surface and is extended toward the chamfered surface intersects the chamfered surface is a fourth intersection point, the chamfered surface at the fourth intersection point has a curvature radius of 110 μm or less.

11. The glass sheet according to claim 2, wherein,
in the cross section perpendicular to the main surface and the first end surface,
the imaginary line of the chamfered surface is inclined with respect to the imaginary line of the first end surface at an inclination angle θ, and the inclination angle θ is 30° to 60°.

12. The glass sheet according to claim 2, wherein the first end surface has a surface roughness Ra of 0.1 μm or less.

13. The glass sheet according to claim 2, wherein the glass sheet has an average internal transmittance of 90% or more at a light path length of 50 mm and a wavelength of 400 to 700 nm.

14. The glass sheet according to claim 2, wherein a surface roughness Ra of the chamfered surface is equal to or more than a surface roughness Ra of the first end surface.
